(19) United States
(12) Patent Application Publication
(10) Pub. No.: US 2008/0196544 A1
(43) Pub. Date: Aug. 21, 2008

(54) Starter having excessive-torque-absorbing device

(75) Inventors: Sadayoshi Kajino, Nagoya-city (JP); Yukio Nawa, Gifu-city (JP)

Correspondence Address: OLIFF & BERRIDGE, PLC, P.O. BOX 320850, ALEXANDRIA, VA, 22320-4850, US

(73) Assignee: DENSO CORPORATION, KARIYA-CITY (JP)

(21) Appl. No.: 11/907,481

(22) Filed: Oct. 12, 2007

(30) Foreign Application Priority Data
Feb. 20, 2007 (JP) 2007-039849
Mar. 12, 2007 (JP) 2007-061937

(51) Int. Cl. F02N 15/06

(52) U.S. Cl. 74/7 E

(57) ABSTRACT

A starter for cranking an internal combustion engine includes a device for absorbing a rotational torque exceeding a predetermined level. In this device, a laminated body composed of fixed disks and the rotatable disks is used. A frictional force in the laminated body is preset by a spring member pressing the laminated body in the laminated direction. To avoid concentration of the pressing force to a position where the spring force is imposed, a certain gap is formed between the spring member and the laminated body. To give a proper surface hardness to an internal gear portion of the rotatable disk and to give an abrasion-resistive property to a portion contacting the fixed disk, the rotatable disk is subjected to soft nitriding treatment. Thus, a stable frictional force is secured in the laminated body, and a long life of the excessive-torque-absorbing device is realized.

### CROSS-REFERENCE TO RELATED APPLICATIONS

This application is based upon and claims benefit of priority of Japanese Patent Applications No. 2007-39849 filed on Feb. 20, 2007 and No. 2007-61937 filed on Mar. 12, 2007, the contents of which are incorporated herein by reference.

### BACKGROUND OF THE INVENTION

1. Field of the Invention

The present invention relates to a starter for cranking an internal combustion engine, the starter having an excessive-torque-absorbing device.

2. Description of Related Art

An example of an excessive-torque-absorbing device used in a starter is disclosed in JP-A-2005-113816. A relevant portion of this device is shown in FIGS. 15 and 16 attached hereto. Fixed disks 120 and rotatable disks 110 are alternately laminated to form a laminated body. The laminated body is contained in a cylindrical casing 100, and pushed in the laminated direction by disk springs 130 to thereby control a frictional force between the fixed disks 120 and the rotatable disks 110. The laminated body contained in the cylindrical casing 100 is pushed in the laminated direction together with the disk springs 130 by a nut 140 disposed at one end of the laminated body.

Internal gears 150 engaging with planetary gears of a planetary gear speed reduction device used in the starter are formed integrally with the rotatable disks 110. When a rotational torque exceeding a predetermined level is applied to the rotatable disks 110, the rotatable disks 110 rotate relative to the fixed disks 120 against friction between the rotatable disks 110 and the fixed disks 120. Thus, an excessive torque is absorbed by the device.

In the device described above, the pushing force of the disk springs 130 is concentrated to an outer periphery of the fixed disks 120 and the rotatable disks 110 as shown with an arrow X in FIG. 15. Accordingly, the outer peripheral portions of the fixed disks 120 and the rotatable disks 110 closely contact each other as shown in FIG. 16. This may cause seizing between the fixed disks 120 and the rotatable disks 110, making a slipping torque in the laminated body unstable, resulting in a shorter life of the excessive-torque-absorbing device.

There has been another problem to be solved in the conventional excessive-torque-absorbing device. That is, the internal gear portion 150 of the rotatable disk 110 must have a hardness comparable to that of the planetary gears, while a portion contacting the fixed disk 120 must have a hardness comparable to that of the fixed disks 120 that is made of a material such as phosphor-bronze. When the rotatable disk made of a material such as carbon steel is heat-treated, its surface hardness becomes higher than HV-700 which is, too hard for the contacting portion.

### SUMMARY OF THE INVENTION

The present invention has been made in view of the above-mentioned problems, and an object of the present invention is to provide an improved starter having an excessive-torque-absorbing device, in which a laminated body including fixed disks and rotatable disks is uniformly pushed by a spring member and a slipping torque between the rotatable disks and the fixed disks is stably maintained.

The starter for cranking an internal combustion engine according to the present invention is composed of an electric motor for generating a rotational torque, an output shaft having a pinion gear that engages with a ring gear of the engine, a planetary gear speed reduction device for transmitting the rotational torque of the motor after reducing its speed, an excessive-torque-absorbing device for absorbing an excessive torque generated when the pinion gear engages with the ring gear and cranking operation is initiated, and other associated components.

The excessive-torque-absorbing device includes fixed disks and rotatable disks laminated alternately with the fixed disks, forming a laminated body. The laminated body is contained in a cylindrical casing having a circular rear end portion. The fixed disks and the rotatable disks are ring-shaped. The fixed disks are fixedly held in the cylindrical casing while the rotatable disks are disposed in the casing so that the rotatable disks rotate relative to the fixed disks when a torque exceeding a predetermined frictional force is imposed on the laminated body.

The frictional force in the laminated body is given by disk springs pushing the laminated body in the laminated direction, and an amount of the frictional force is preset by fastening a screw at a front end of the cylindrical casing. The pushing force of the disk springs is imposed on a pushing plate, which is disposed at the front end of the laminated body, at a specific position, such as at the outer periphery of the fixed disk or at a potion a certain distance inside of the outer periphery. If the pushing force concentrates to the specific position, the laminated body is not uniformly pressed. To avoid the concentration of the pushing force, a certain gap is formed between the pushing plate and a fixed disk disposed at an end of the laminated body. The gap is formed at a position where the pushing force is imposed. Thus, the pushing force is uniformly imposed on the laminated body, realizing a stable frictional force in the laminated body.

The rotational disk is formed integrally with an internal gear of the planetary gear speed reduction device. The internal gear engaging with the planetary gears has to have a hardness comparable to a hardness of the planetary gears, while a portion contacting the fixed disk must have a good abrasion-resistant property. To give the rotatable disk these properties, it is subjected to a treatment of soft nitriding. In addition, a confined grease space is formed in the cylindrical casing at an outer peripheral portion of the rotatable disks to keep the grease longer.

According to the present invention, the frictional force set in the excessive-torque-absorbing device is stabilized and a life of the device is prolonged. Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing an excessive-torque-absorbing device as a first embodiment of the present invention;

FIG. 2 is a cross-sectional view showing the excessive-torque-absorbing device and other structures in its vicinity;

FIG. 3 is a cross-sectional view showing a starter having the excessive-torque-absorbing device;

FIG. 4A is a plan view showing a fixed disk used in the excessive-torque-absorbing device;

FIG. 4B is a plan view showing a rotatable disk used in the excessive-torque-absorbing device;

FIG. 5 is a plan view showing a cylindrical casing in which a laminated body of rotatable disks and fixed disks is contained, viewed from a rear side of the starter;

FIG. 6 is a plan view showing a cylindrical casing in which a laminated body of rotatable disks and fixed disks is retained by a nut, view from a front side of the starter;

FIG. 7 is a schematic view showing a size of a gap formed in a pushing plate relative to its diameter;

FIG. 8 is a plan view showing a portion of a fixed disk and an area contacting a rotatable disk;

FIG. 9 is a cross-sectional view showing a half of an excessive-torque-absorbing device as a second embodiment of the present invention;

FIG. 10 is a partial cross-sectional view showing a pushing plate formed by stamping;

FIG. 11 is a cross-sectional view showing an excessive-torque-absorbing device as a third embodiment of the present invention;

FIG. 12 is a cross-sectional view showing an excessive-torque-absorbing device as a fourth embodiment of the present invention;

FIG. 13 is a cross-sectional view showing an excessive-torque-absorbing device as a fifth embodiment of the present invention;

FIG. 14 is a partial cross-sectional view showing an iron-nitride compound layer and a nitrogen-diffused layer formed on a surface of a rotatable disk by a soft nitriding process;

FIG. 15 is a cross-sectional view showing a half of a conventional excessive-torque-absorbing device used in a starter; and

FIG. 16 is a partial plan view showing a fixed disk and an area contacting a rotatable disk in the conventional excessive-torque-absorbing device.

### DETAILED DESCRIPTION OF THE PREFERRED EMBODIMENTS

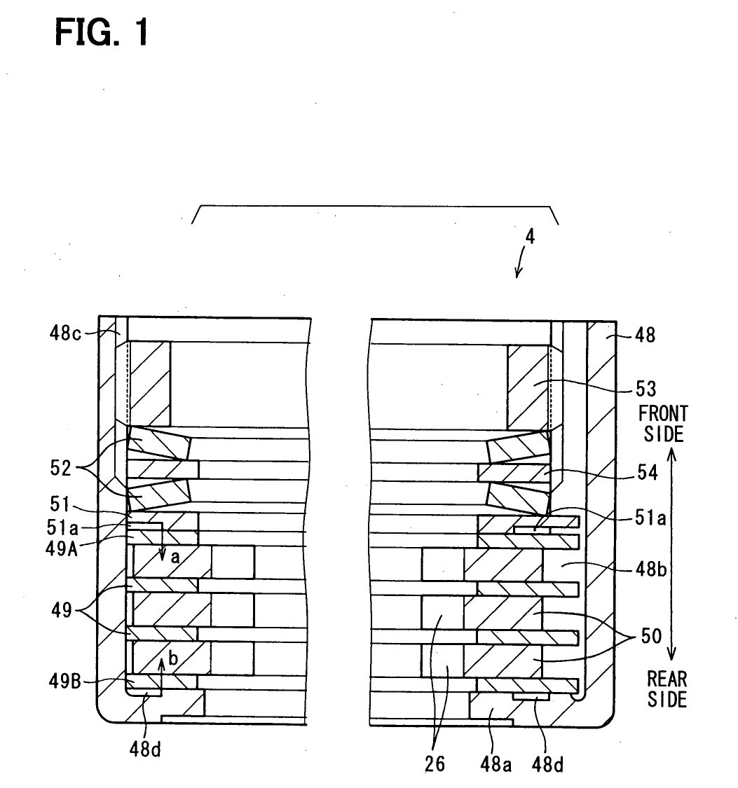

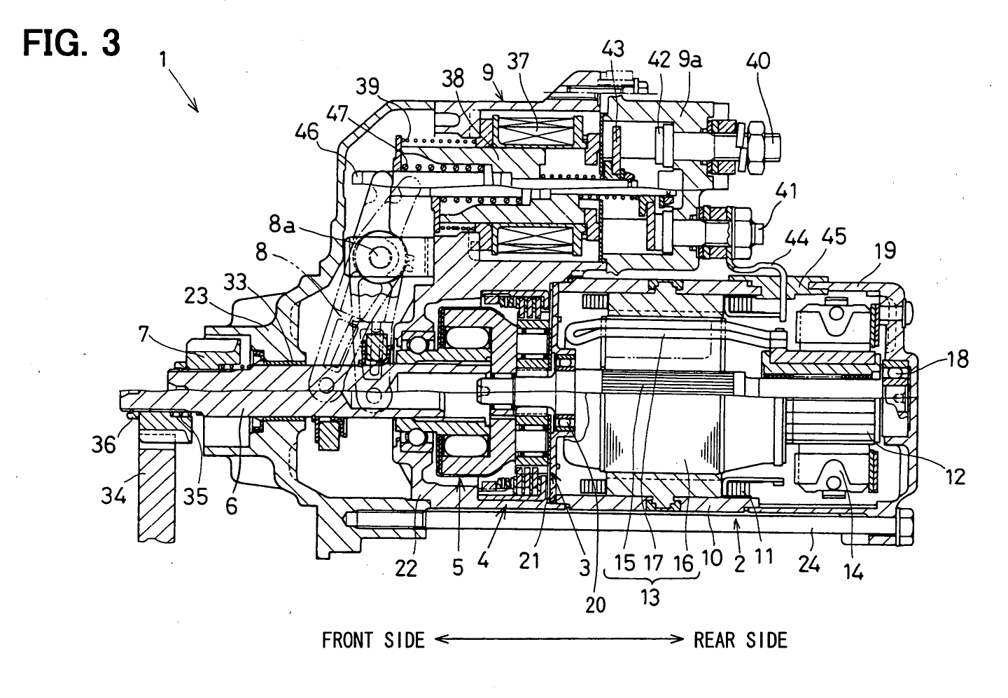

A first embodiment of the present invention will be described with reference to FIGS. 1-8. First, referring to FIG. 3, an entire structure of a starter 1 in which an excessive-torque-absorbing device 4 is installed. The starter 1 includes: an electric motor 2 generating a rotational torque; a planetary gear speed reduction device 3 for reducing a rotational speed of the electric motor 2; an excessive-torque-absorbing device 4 for absorbing an excessive torque in a starting operation; an output shaft 6 connected to the planetary gear speed reduction device 3 via a clutch 5; a pinion gear 7 supported on the output shaft 6; and an electromagnetic switch 9 forming a circuit for turning on the electric motor 2.

The electric motor 2 is a known direct current motor composed of a yoke 10 forming a magnetic circuit, field coils 11 disposed in the yoke 10, an armature 13 having a commutator 12, brushes 14 slidably contacting the commutator 12 and other components. It is possible to use permanent magnets in place of the field coils 11. The armature 13 includes an armature core 16 connected to an armature shaft 15 and armature coils 17 wound around the armature core 16, and the armature coils 17 are connected to segments forming the commutator 12. The armature shaft 15 is rotatably supported by a bearing 18 fixed in an end frame 19 at the rear side and by a bearing 20 fixed in a center plate 21 at a front side. The front side and the rear side of the starter are indicated by an arrow in FIG. 3 and other drawings.

The center plate 21 is disposed between the armature 13 and the planetary gear speed reduction device 3, so that foreign particles including brush powders are prevented from entering into the planetary gear speed reduction device 3. An outer periphery of the center case 21 is sandwiched between a center case 22 and the yoke 10. The center case 22 is disposed between a front housing 23 covering a front side of the starter 1 and the yoke 10, and covers the outside of the clutch 5 and the planetary gear speed reduction device 3. The front housing 23, the center case 22, the yoke 10 and the end frame 19 are connected together with plural through-bolts 24.

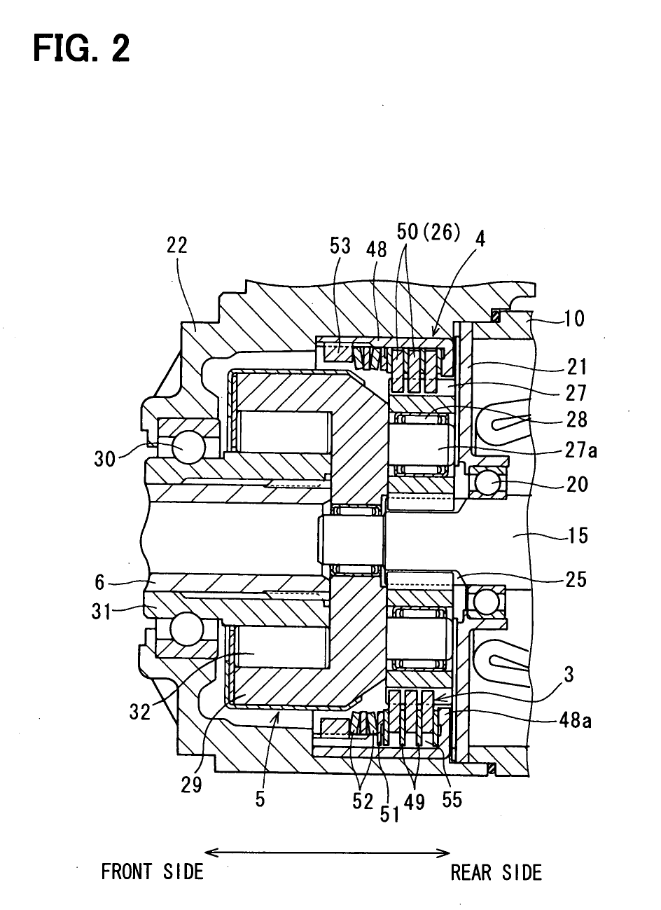

The planetary gear speed reduction device 3 is disposed coaxially with the armature shaft 15. As shown in FIG. 2, the device 3 is composed of a sun gear 25 formed on the armature shaft 15 at a position extending through the center plate 21, an internal gear 26 formed as part of the excessive-torque-absorbing device 4 and planetary gears 27 engaging with both of the sun gear 25 and the internal gear 26. The internal gear 26 is usually restrained, and the planetary gears 27 orbit around the sun gear 25. The orbital movement of the planetary gears 27 around the sun gear 25 is transmitted to the output shaft 6 via the clutch 5. The planetary gears 27 are rotatably supported by pins 27a fixed to a clutch outer 29 of the one-way clutch 5 via respective bearings 28 such as needle bearings.

The one-way clutch 5 transmits a rotational torque of the electric motor 2 to the output shaft 6 while preventing torque transmission from the output shaft 6 to the electric motor 2. The one-way clutch 5 is composed of: a clutch outer 29 that is rotated according to the orbital rotation of the planetary gears 27; an inner tube 31 rotatably supported in the center case 22 via a bearing 30; and rollers 32 disposed between the inner tube 31 and the clutch outer 29 to connect or interrupt torque transmission between the clutch outer 29 and the inner tube 31.

As shown in FIG. 3, a front end portion of the output shaft 6 is rotatably and slidably supported by the front housing 23 via a bearing 33, and its rear end portion is spline-coupled to an inner bore of the inner tube 31 of the one-way clutch 5. A pinion gear 7 is coupled to a front end of the output shaft 6 to be movable in the axial direction, and is biased in a frontward direction by a pinion spring 35 to abut a stopper 36. The pinion gear 7 engages with the ring gear 34 of the engine and transmits the rotational torque of the electric motor 2 to the engine when the output shaft 6 is shifted frontward in the manner described below. In FIG. 3, portions above a centerline of the output shaft 6 and a centerline of the electromagnetic switch 9 show a non-engaging state where the pinion gear 7 is not engaged with the ring gear 34, while portions below those centerlines show an engaging state where the pinion gear 7 engages with the ring gear 34.

The electromagnetic switch 9 includes an electromagnetic coil 37 that is excited by supplying current from an on-boar battery and a plunger 38 that is slidably movable in the axial direction within an inner bore of the electromagnetic coil 37. When the plunger 37 moves in the rear side by excitation of the electromagnetic coil 37, a main switch for supplying electric current to the electric motor 2 is closed. When the electromagnetic coil 37 is de-energized, the plunger 38 returns to its original position by a biasing force of a return spring 39, and the main switch is opened.

The main switch is composed of a pair of fixed contacts 42 connected to respective external terminals 40, 41 and a movable contact 43 connected to the plunger 38. When the movable contact 43 contacts the pair of fixed contacts 42, the main switch is closed. When the movable contact 43 is separated from the pair of contacts 42, the main switch is opened. The external terminals 40, 41 are fixed to a resin cover 9a of the electromagnetic switch 9. The external terminal 40 is a B-terminal connected to a plus terminal of the on-board battery through a battery cable, and the external terminal 41 is an M-terminal connected to the electric motor 2 through a motor terminal 44. The motor terminal 44 is held by a grommet 45 sandwiched between the yoke 10 and the end frame 19, and one end of the motor terminal 44 is connected to the field coil 11 of the electric motor 2.

A shift lever 8 is pivotally supported by a fulcrum 8a. One end of the shift lever 8 is connected to a shift rod 46 of the electromagnetic switch 9, and the other end thereof is coupled to the output shaft 6. The shift rod 46 is assembled to the plunger 38 together with a driving spring 47, and the movement of the plunger 38 is transmitted to the shift rod 46 via the driving spring 47. The output shaft 6 is shifted frontward according to the movement of the shift rod 46 in the rearward direction.

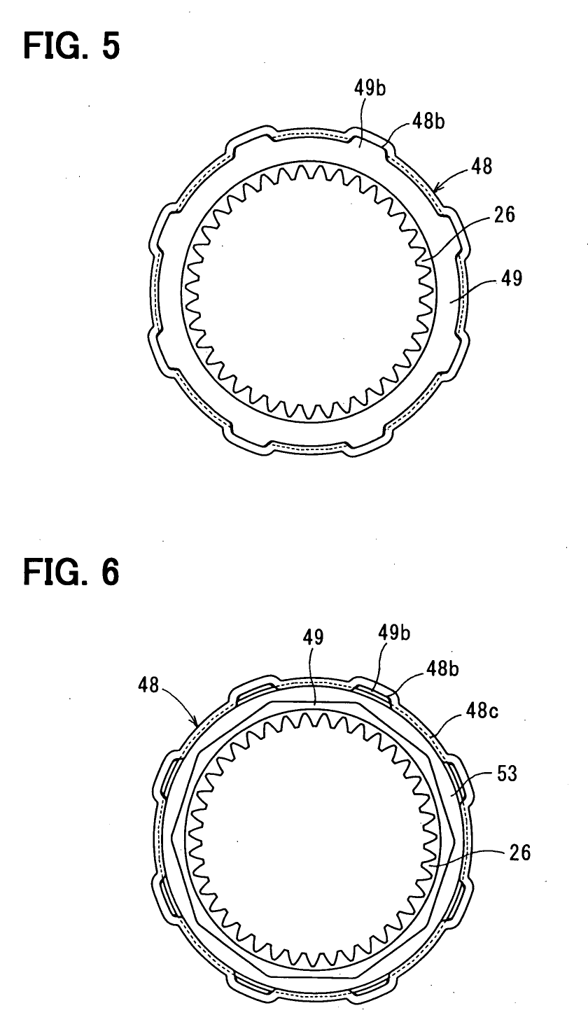

Now, the excessive-torque-absorbing device 4 will be described with reference to FIG. 1. The excessive-torque-absorbing device 4 is composed of a cylindrical casing 48, fixed disks 49, rotatable disks 50, a pushing plate 51, a washer 54 and disk springs 52. The cylindrical casing 48 having a circular rear end 48a bent from a cylindrical portion is inserted into an inner bore of the center case 22 (refer to FIG. 2) and fixed to it not to rotate. An inner diameter of the circular rear end 48a is made not to interfere with the planetary gears 27 of the planetary gear speed reduction device 3. Depressed portions 48b that prevent rotation of the fixed disks 49 are formed on an inner periphery of the cylindrical casing 48 (refer to FIG. 5). A female screw 48c is formed at a front end of the cylindrical casing 48.

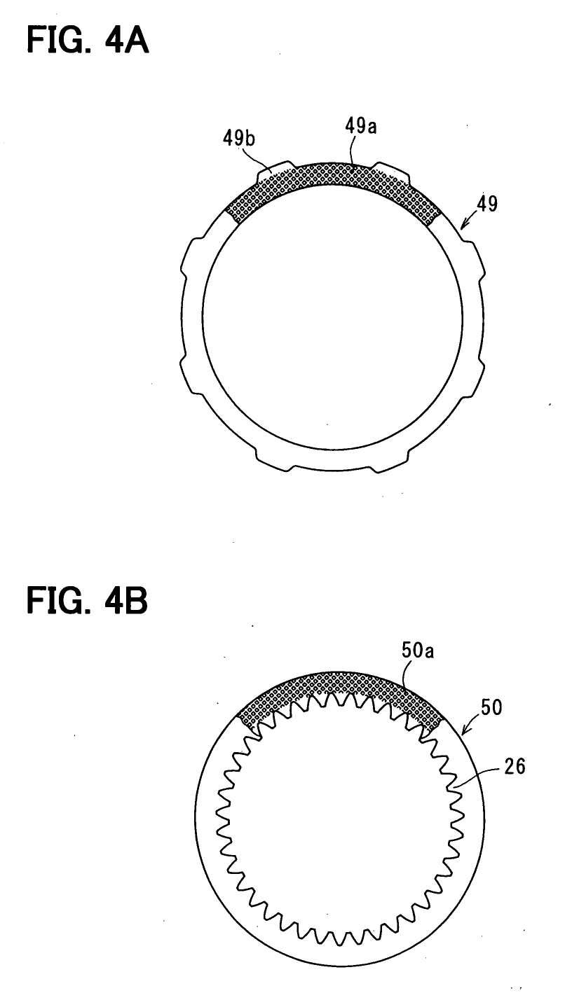

As shown in FIG. 1, the fixed disks 49 and the rotatable disks 50 are alternately laminated, and the fixed disks 49 are disposed at both axial ends, forming a laminated body. The laminated body is contained in the cylindrical casing 48. The fixed disk 49 is made of a material such as phosphor-bronze, and is formed in a ring-shape by stamping as shown in FIG. 4A. Dimples 49a are formed on both surfaces of the fixed disk 49. Projected portions 49a are formed on the outer periphery of the fixed disk 49, so that the projected portions 49a engage with the depressed portions 48b of the cylindrical casing 48 to thereby prevent rotation of the fixed disk 49 in the cylindrical casing 48 (refer to FIG. 5). The inner diameter of the fixed disks 49 is made not to interfere with the planetary gears 27 of the planetary gear speed reduction device 3.

As shown in FIG. 4B, the rotatable disk 50 is made of a metallic plate such as a steel plate by stamping into a ring shape. Dimples 50a are formed on surfaces of the rotatable disk 50. The outer diameter of the rotatable disk 50 is made a little smaller than the inner diameter of the cylindrical casing 48. The rotatable disks 50 are disposed in the cylindrical casing 48 to be able to rotate relative to the fixed disks 49. The internal gear 26 is formed on the inner periphery of each rotatable disk 50, i.e., the internal gear 26 is formed integrally with the rotatable disk 49. The internal gear engaging with the planetary gears 27 of the planetary gear speed reduction device 3 is formed by laminated plural internal gears 26. Surfaces of the fixed disks 49 and the rotatable disks 50 are coated with lubricating grease. The laminated body of the fixed disks 49 and the rotatable disks 50 is disposed in the cylindrical casing 48 as shown in FIGS. 5 and 6.

As shown in FIG. 1, the pushing plate 51 is formed in a ring shape similar to the shape of the fixed disk 49 and disposed at a front end of the laminated body. Two disk springs 52 in a ring shape are disposed in the cylindrical casing 48 to push the pushing plate 51 in the axial direction of the laminated body. A frictional force between the rotatable disks 50 and the fixed disks 49 is properly adjusted by fastening a nut 53 to a female screw 48c formed at the front end of the cylindrical casing 48. Two disk springs 52, with a washer 54 disposed therebetween, are used in this particular embodiment. It is possible, however, to use a single disk spring 52.

Now, a pushing force of the disk springs 52 generating the frictional force in the laminated body will be described in detail. As shown in FIG. 1, the pushing force of the disk spring 52 is imposed on the outer peripheral portion of the pushing plate 51. A gap 51a is formed on the pushing plate 51 so that the pushing force of the disk spring 52 does not concentrate to the outer periphery of the front fixed disk 49A (a fixed disk 49 disposed at the front end of the laminated body is referred to as a front fixed disk 49A). The gap 51a is formed by making a step on a surface of the pushing plate 51 as shown in FIG. 1. In this manner, the pushing force is imposed on the front fixed disk 49A at a portion inside the gap 51a, and the concentration of the pushing force to the outer periphery of the front fixed disk 49A is avoided.

On an inner surface of the circular rear end portion 48a of the cylindrical casing 48, a step forming a gap 48d is made as shown in FIG. 1. The gap 48d serves to avoid concentration of the pushing force on the outer periphery of the rear fixed disk 49B (a fixed disk 49 disposed at the rear end of the laminated body is referred to as a rear fixed disk 49B). In other words, the pushing force is imposed on the rear fixed disk 49B at a position inside the gap 48d. The pushing force generated by the disk springs 52 is imposed on the front fixed disk 49A as shown with an arrow “a” in FIG. 1 and on the rear fixed disk 49B as shown with an arrow “b”.

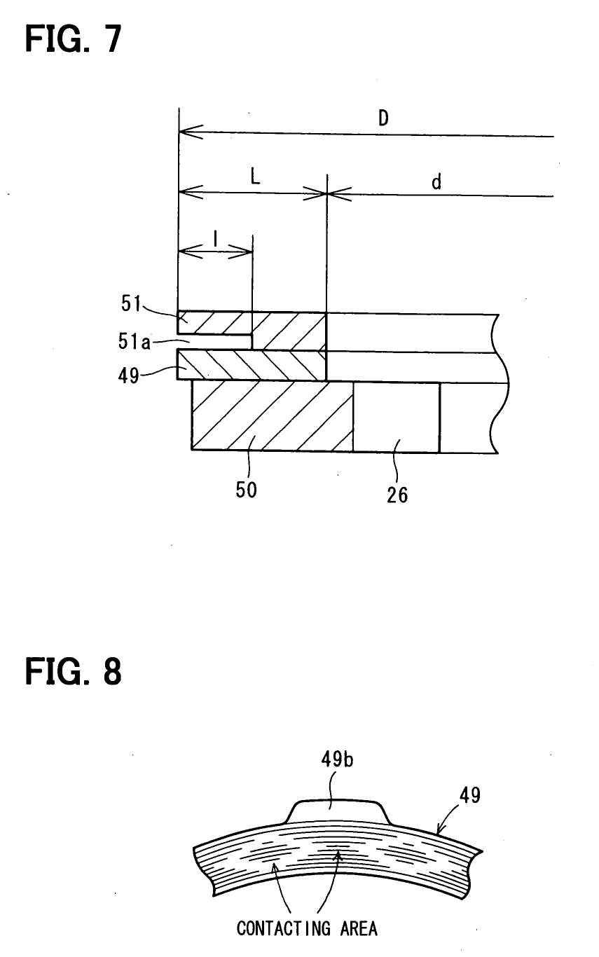

A size of the gap 51a relative to a friction area between the fixed disk 49 and the rotatable disk 50 is shown in FIG. 7. That is, length I of the gap 51a in the radial direction is made in a range from ⅓ to ⅔ of the radial length L of the friction area. Namely, I=(⅓ to ⅔)L, where L=½(D−d), D is an outer diameter of the fixed disk 49, and d is an inner diameter of the fixed disk 49. Most preferably, I is made a half of L.

Operation of the starter 1 will be briefly explained. Upon turning on a starter switch, the electromagnetic coil 37 in the electromagnetic switch 9 is energized, and the plunger 38 is attracted to the electromagnetic coil 37. The movement of the plunger 38 is transmitted to the output shaft 6 via the shift lever 8. The output shaft 6, helical-coupled to the inner tube 31, is shifted frontward while rotating. The pinion gear 7 coupled to the output shaft 6 abuts an axial surface of the ring gear 34 and stops there, while the pinion spring 35 being compressed. Then, the plunger 38 further moves rearward, while compressing the driving spring 47, and the main switch is closed to supply electric power to the electric motor 2.

Upon closing the main switch, the electric motor 2 begins to rotate. The rotational torque of the electric motor 2 is transmitted to the output shaft 6 via the one-way clutch 5 while the rotational speed is reduced by the planetary gear speed reduction device 3. The pinion gear 7 is forcibly rotated up to a position where engagement with the ring gear 34 is possible, and the pinion gear 7 engages with the ring gear 34. The ring gear 34 is rotated by the rotational torque of the pinion gear 7, thereby cranking up the engine.

At the moment when the pinion gear 7 engages with the ring gear 34 and starts cranking operation of the engine, an excessive torque (an impact torque) is imposed on the internal gear 26 through the pinion 7, the output shaft 6, the inner tube 31, the rollers 32, the clutch outer 29 and the planetary gears 27. If the impact torque exceeds a predetermined frictional torque between the fixed disks 49 and the rotatable disks 50, slippage occurs between the fixed disks 49 and the rotatable disks 50. In other words, the rotatable disks 50 rotates against the preset frictional force in the excessive-torque-absorbing device 4, and thus the excessive torque is absorbed.

After the engine is cranked up, the electromagnetic coil 37 is de-energized by turning off the starter switch. The plunger 38 returns to its initial position by the spring-back force of the return spring 39. Power supply to the electric motor 2 is terminated, and the output shaft 6 returns to its initial position by the shift lever 8 returning to its initial position.

Advantages attained in the first embodiment will be summarized below. Since the gap 51a is formed on the pushing plate 51, the pushing force of the disk springs 52 are imposed on the front fixed disk 49A at the position shown with the arrow “a” in FIG. 1. Similarly, since the gap 48d is formed on the circular rear end portion 48a of the cylindrical casing 48, the counter-force is imposed on the rear fixed disk 49B at the position shown with the arrow “b”. This means that the laminated body is not pressed at its outer periphery, but it is pressed at a middle portion between the outer diameter and the inner diameter of the fixed disk 49.

Thus, concentration of the pushing force to the outer periphery of laminated body is avoided, and substantially uniform pushing force is imposed on the contacting area between the fixed disks 49 and the rotatable disks, as shown in FIG. 8. Thus, a stable frictional force in the laminated body can be obtained. Seizing between the fixed disks 49 and the rotatable disks 50 is prevented, and a life of the excessive-torque-absorbing device is prolonged. In addition, the excessive-torque-absorbing device 4 of the present invention may be applied to a starter for a diesel engine that requires a high torque.

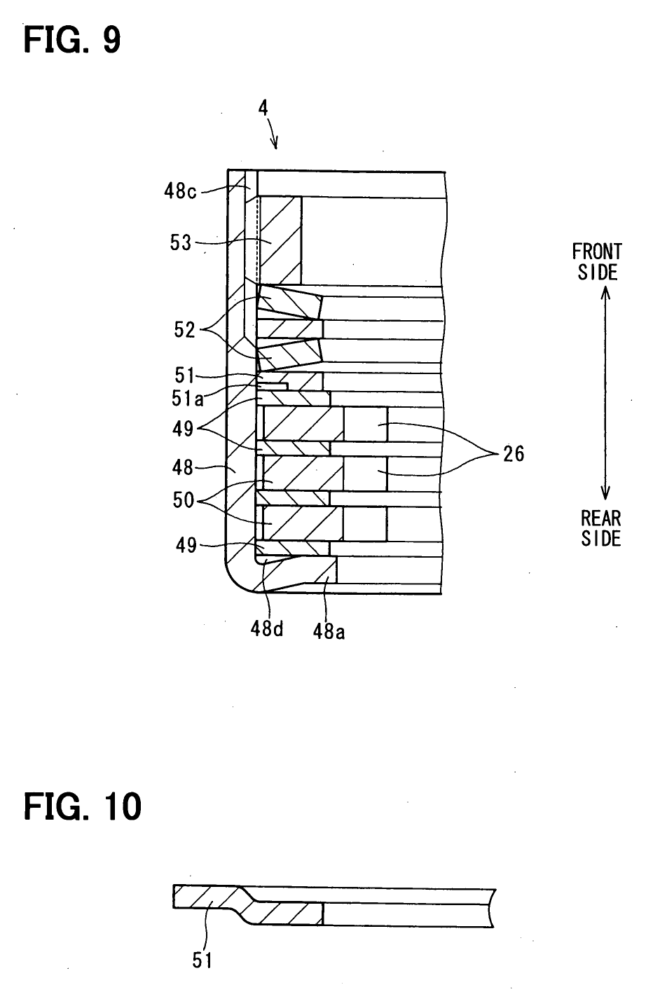

A second embodiment of the present invention is shown in FIG. 9. In this embodiment, the gap 48d formed on the circular rear end portion of the cylindrical casing 48 is modified to a tapered form. Other structures and functions are the same as those of the first embodiment. The pushing plate 51 may be modified to a form shown in FIG. 10. In the pushing plate shown in FIG. 10, a step for forming the gap 51a is formed by stamping.

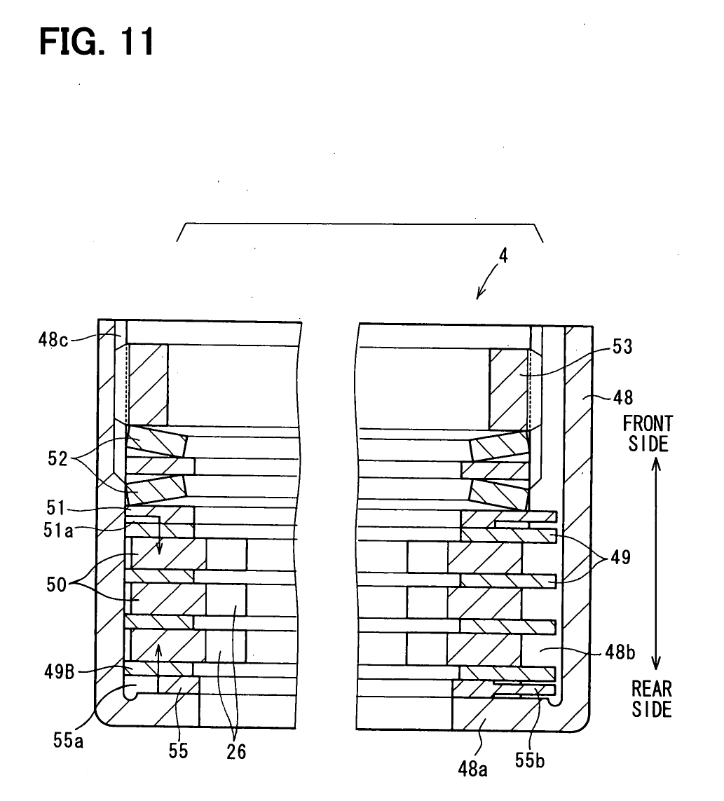

A third embodiment of the present invention is shown in FIG. 11. In this embodiment, another pushing plate 55 is disposed between the rear fixed disk 49B and the circular rear end portion 48a of the cylindrical casing 48. The outer diameter of the pushing plate 55 is made smaller than the outer diameter of the fixed disk 49, thereby forming a gap 55a that corresponds to the gap 48d of the first embodiment. On the outer periphery of the pushing plate 55, projected portions 55b engaging with the depressions 48b of the cylindrical casing 48 are formed. The pushing plate 55 is prevented from rotating and moving in the radial direction by the projected portions 55b. Other structures and functions of the third embodiment is the same as those of the first embodiment.

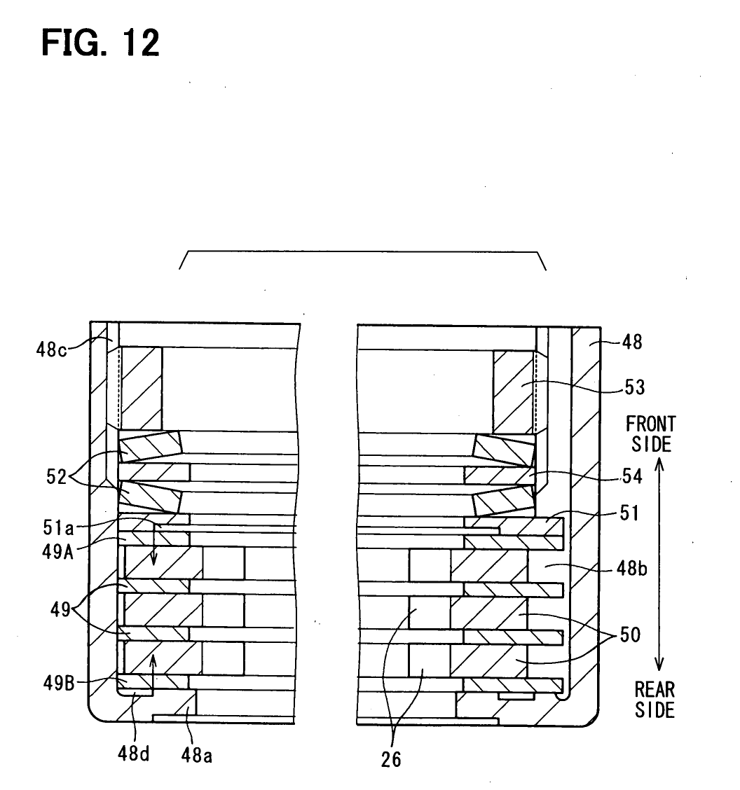

A fourth embodiment of the present invention is shown in FIG. 12. In this embodiment, a pushing force of the disk springs 52 is imposed on the pushing plate 51 at an inner position, not at the outer peripheral position. The gap 51a of the pushing plate 51 is formed at the position where the pushing force is imposed. In this manner, concentration of the pushing force is avoided and the laminated body is pressed substantially uniformly. The gap 48d at the rear end of the laminated body is similarly formed as in the first embodiment.

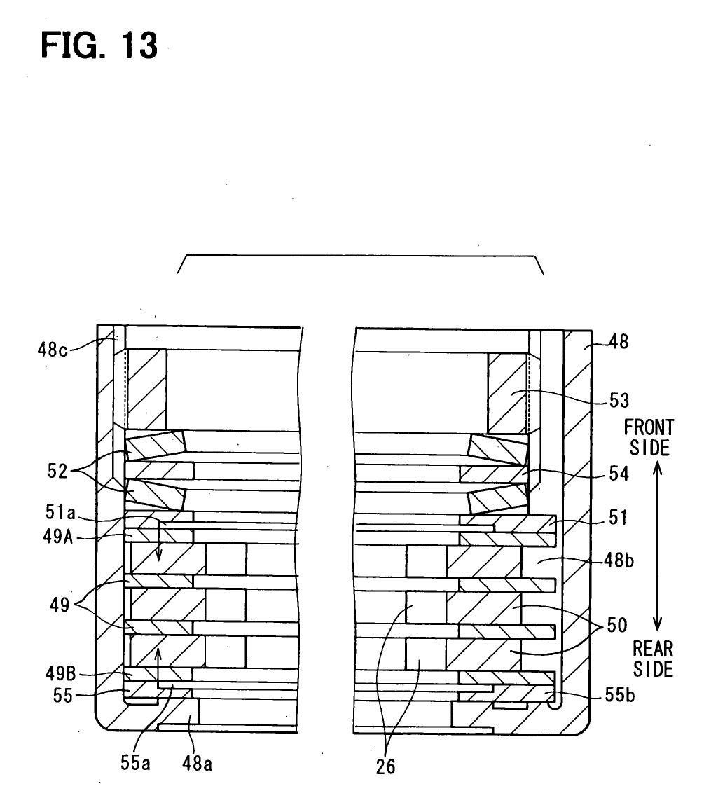

A fifth embodiment of the present invention is shown in FIG. 13. In this embodiment, the pushing force of the disk springs 52 is imposed on the inner position of the pushing plate 51 in the same manner as in the fourth embodiment. The gap 51a is formed at the position where the pushing force is imposed in the same manner as in the fourth embodiment. A second pushing plate 55 having a gap 55a formed at an inside position is additionally used in this embodiment. Concentration of pushing force to the inside position where the pushing force is imposed is avoided, and the laminated body is uniformly pressed, generating a stable frictional force therein. Projected portions 55b engaging with the depressed portion 48b of the cylindrical casing 48 are formed on the outer periphery of the second pushing plate 55 to prevent rotation and radial movement of the second pushing plate 55.

Grease for the excessive-torque-absorbing device 4 is contained in a grease space 55 shown in FIG. 2. The grease space 55 is a space confined by an outer periphery of the rotatable disks 50, an inner periphery of the depressed portions 48b and fixed disks 49 disposed both end of the laminated body. For example, the grease may be lithium-type grease containing lithium soap added to base lubricant as a thickener, and further containing an extreme-pressure additive and a solid additive such as molybdenum disulfide. Since the grease space 55 is a confined space, the grease can be kept for a long time without easily flowing out.

The same grease may be used for both the planetary gear speed reduction device 3 and the excessive-torque-absorbing device 4. If a different type of grease from the grease used for the excessive-torque absorbing device 4 is used for the planetary gear speed reduction device 3, it is most preferable to make an amount of grease used in the planetary gear speed reduction device 3 less than one half of an amount of the grease used in the excessive-torque-absorbing device 4. This is because a friction coefficient of the lithium type grease containing additives mentioned above changes when another type of grease is mixed in an amount in excess of 50% of own grease. The preset frictional torque in the excessive-torque-absorbing device 4 is changed according to changes in the friction coefficient of the grease.

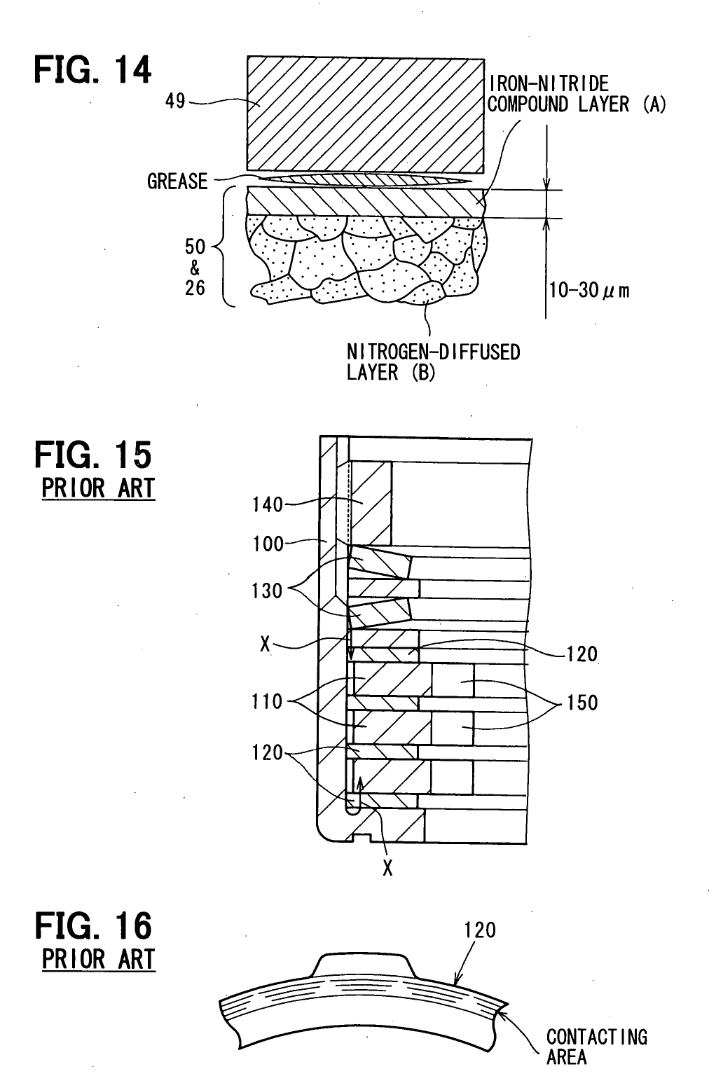

The rotatable disk 50 is made of low carbon steel or medium carbon steel, and soft nitriding treatment is performed to form an iron-nitride compound layer (A) and a nitrogen-diffused layer (B) thereon, as shown in FIG. 14. The iron-nitride compound layer (A) is 10-30 μm thick and has a hardness of HV 500-650. The thickness and the hardness of the layer (A) may be adjusted by changing a period of time for performing the soft nitriding treatment. Underneath the layer (A) the nitrogen-diffused layer (B) is formed. An entire surface of the rotatable disk 50 including a portion forming the internal gear 26 is subjected to the soft nitriding treatment. It is also possible to perform the soft nitriding only to the surface contacting the fixed disk 49 masking the surface forming the internal gear 26.

Since the iron-nitride compound layer (A) has a hardness of HV 500-650 that is comparable to a hardness of the planetary gear 27 engaging with the internal gear 26 and a thickness of 10-30 μm, abrasion wear of the internal gear 26 is suppressed. Since the iron-nitride compound layer (A) has an excellent property in lubrication, abrasion wear of the fixed disk 49 contacting the rotatable disk 50 is suppressed. This means that the rotatable disk 50 subjected to the soft nitriding treatment satisfies both properties required by the rotatable disk 50 and the internal gear 26. Further, a friction coefficient of the iron-nitride compound layer (A) is low and stable, a stable frictional torque can be obtained in the laminated body.

While the present invention has been shown and described with reference to the foregoing preferred embodiments, it will be apparent to those skilled in the art that changes in form and detail may be made therein without departing from the scope of the invention as defined in the appended claims.

What is claimed is:

1. A starter for cranking an internal combustion engine, the starter comprising:
an electric motor outputting a rotational torque;
an output shaft having a pinion gear for engaging with a ring gear of the engine;
planetary gear speed reduction device for transmitting the rotational torque of the electric motor to the output shaft while reducing rotational speed of the electric motor; and
an excessive-torque-absorbing device having: rotatable disks integrally formed with an internal gear of the planetary gear speed reduction device; fixed disks laminated alternately with the rotatable disks, thereby forming a laminated body that includes a front fixed disk positioned at a front end of the laminated body and a rear fixed disk positioned at a rear end of the laminated body, the laminated body being contained in a cylindrical casing having a circular rear end portion; a pushing plate contacting the front fixed disk; and a spring member pushing the pushing plate to thereby press the laminated body in a laminated direction, the spring member pushing the pushing plate at its outer periphery, wherein:
a gap having a predetermined radial length measured from the outer periphery of the front fixed disk is formed between the front fixed disk and the pushing plate to thereby avoid concentration of a pushing force of the spring member to the outer periphery of the front fixed disk.

2. The starter for cranking an internal combustion engine as in claim 1, wherein:
the rear fixed disk contacts the circular rear end portion of the cylindrical casing; and
a second gap having a predetermined radial length measured from an outer periphery of the rear fixed disk is formed between the circular rear end portion and the rear fixed disk.

3. The starter for cranking an internal combustion engine as in claim 1, wherein:
the excessive-torque-absorbing device further includes a second pushing plate disposed between the rear fixed disk and the circular rear end portion of the cylindrical casing; and
a second gap having a predetermined radial length measured from an outer periphery of the rear fixed disk is formed between the circular rear end portion and the rear fixed disk.

4. A starter for cranking an internal combustion engine, the starter comprising:
an electric motor outputting a rotational torque;
an output shaft having a pinion gear for engaging with a ring gear of the engine;
planetary gear speed reduction device for transmitting the rotational torque of the electric motor to the output shaft while reducing rotational speed of the electric motor; and
an excessive-torque-absorbing device having: rotatable disks integrally formed with an internal gear of the planetary gear speed reduction device; fixed disks laminated alternately with the rotatable disks, thereby forming a laminated body that includes a front fixed disk positioned at a front end of the laminated body and a rear fixed disk positioned at a rear end of the laminated body, the laminated body being contained in a cylindrical casing having a circular rear end portion; a pushing plate contacting the front fixed disk; and a spring member pushing the pushing plate to thereby press the laminated body in a laminated direction, the spring member pushing the pushing plate at a position a certain distance apart from its outer periphery, wherein:
a gap having a predetermined radial length is formed between the front fixed disk and the pushing plate in an area corresponding to the position where the spring member pushes the pushing plate to thereby avoid concentration of a pushing force of the spring member to the position where the spring member pushes the pushing plate.

5. The starter for cranking an internal combustion engine as in claim 4, wherein:
the excessive-torque-absorbing device further includes a second pushing plate disposed between the rear fixed disk and the circular rear end portion of the cylindrical casing; and
a second gap is formed between the rear fixed disk and the second pushing plate in an area a certain distance apart from an outer periphery of the second pushing plate.

6. The starter for cranking an internal combustion engine as in claim 1, wherein: the fixed disk is ring-shaped; and the radial length I of the gap is set in a range ⅓ to ⅔ of L, where L=½(D−d), D is an outer diameter of the fixed disk and d is an inner diameter of the fixed disk.

7. The starter for cranking an internal combustion engine as in claim 4, wherein: the fixed disk is ring-shaped; and the radial length I of the gap is set in a range of ⅓ to ⅔ of L, where L=½ (D−d), D is an outer diameter of the fixed disk and d is an inner diameter of the fixed disk.

8. The starter for cranking an internal combustion engine as in claim 2, wherein: the fixed disk is ring-shaped; and the radial length I of the second gap is set in a range of ⅓ to ⅔ of L, where L=½(D−d), D is an outer diameter of the fixed disk and d is an inner diameter of the fixed disk.

9. The starter for cranking an internal combustion engine as in claim 1, wherein the gap is formed on the pushing plate by stamping.

10. The starter for cranking an internal combustion engine as in claim 4, wherein the gap is formed on the pushing plate by stamping.

11. A starter for cranking an internal combustion engine, the starter comprising:
an electric motor outputting a rotational torque;
an output shaft having a pinion gear for engaging with a ring gear of the engine;
planetary gear speed reduction device for transmitting the rotational torque of the electric motor to the output shaft while reducing rotational speed of the electric motor; and
an excessive-torque-absorbing device having: rotatable disks integrally formed with an internal gear of the planetary gear speed reduction device; fixed disks laminated alternately with the rotatable disks, thereby forming a laminated body, the laminated body being contained in a cylindrical casing having a circular rear end portion; and a spring member pushing the laminated body to thereby press the laminated body in a laminated direction to thereby generate a predetermined frictional force between the rotatable disks and the fixed disks, wherein surfaces of the rotatable disks are subjected to soft nitriding treatment.

12. The starter for cranking an internal combustion engine as in claim 11, wherein a surface hardness of the rotatable disk is HV500 to HV650.

13. The starter for cranking an internal combustion engine as in claim 12, wherein a thickness of an iron-nitride compound layer formed by the soft nitriding is 10-30 μm.

14. The starter for cranking an internal combustion engine as in claim 13, wherein the rotatable disk is made of low carbon steel or medium carbon steel.

15. The starter for cranking an internal combustion engine as in claim 11, wherein: respectively different types of grease are used in the planetary gear speed reduction device and in the excessive-torque-absorbing device; and an amount of grease used in the planetary gear speed reduction device is less than 50 percents of an amount of grease used in the excessive-torque-absorbing device.

16. The starter for cranking an internal combustion engine as in claim 11, wherein:
the fixed disk has projected portions engaging with depressed portions of the cylindrical casing, rotation of the fixed disk in the cylindrical casing being prevented;
a pair of fixed disks are disposed axial ends of the laminated body; and
a grease space for containing grease therein is confined by an inner periphery of the depressed portion of the cylindrical casing, an outer periphery of the rotatable disk and the pair of fixed disks disposed at the axial ends of the laminated body.
